(19) United States
(12) Patent Application Publication
(10) Pub. No.: US 2025/0223416 A1
(43) Pub. Date: Jul. 10, 2025

(54) PLASTIC PRODUCT MANUFACTURED WITH SHREDDED PLASTIC PARTICLES

(71) Applicant: Honeywell Safety Products USA, Inc., Charlotte, NC (US)

(72) Inventor: Isaac Jesus Ponce, Mexico State (MX)

(21) Appl. No.: 18/406,699

(22) Filed: Jan. 8, 2024

(51) Int. Cl. C08J 11/06; B29B 7/02; B29C 35/02; B29C 45/00; B29K 105/16; B29K 105/26; B29L 11/00; C08J 3/00

(52) U.S. Cl. CPC C08J 11/06; C08J 3/005; B29B 7/02; B29C 35/02; B29C 45/0013; B29K 2105/16; B29K 2105/26; B29L 2011/0016; C08J 2367/02

(57) ABSTRACT

A plastic product includes shredded plastic particles disposed within a cured matrix. The cured matrix includes a cured resin. The shredded plastic particles are distinct from the cured matrix of the plastic product. The plastic product is manufactured by forming a mixture by mixing shredded plastic particles with an uncured matrix. The uncured matrix includes an uncured resin. The mixture is injected or poured into a mold. The uncured matrix within the mixture is cured at a temperature that is less than 110 degrees Celsius.

### TECHNICAL FIELD

The present application relates generally to a plastic product and a method of manufacturing the plastic product from shredded plastic particles.

### BACKGROUND

Objects made from plastic are often formed from virgin plastic materials. For example, the plastics used to manufacture the plastic objects are produced from petroleum and are not made from an existing plastic object. Once a plastic object has been used, it is often thrown away or sent to a recycling plant. The plastic objects that are sent to a recycling plant are often recycled or reused to manufacture a new plastic product.

The inventor has identified numerous deficiencies and problems with the existing technologies in this field. Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

In general, embodiments of the present disclosure provided herein include an improved plastic product and a method of manufacturing the plastic product from shredded plastic particles.

In various aspects, a plastic product includes shredded plastic particles disposed within a cured matrix. The cured matrix may include a cured resin. The shredded plastic particles may be distinct from the cured matrix.

In various examples, each of the shredded plastic particles defines a size of less than 0.5 mm.

In various examples, at least some of the shredded plastic particles defines a size of greater than 0.3 mm.

In various examples, a ratio between a volume of shredded plastic particles within the plastic product and a volume of the cured matrix within the plastic product is at least 1:1.

In various examples, the shredded plastic particles comprise primarily of polyethylene terephthalate (PET or PETE), high-density polyethylene (HDPE), polyvinyl chloride (PVC), low-density polyethylene (LDPE), polypropylene (PP), polystyrene (PS), polycarbonate (PC), acrylic (PMMA), or a combination thereof.

In various examples, at least ten percent of the shredded plastic particles comprise primarily of PET or PETE and the other shredded plastic particles comprise primarily of a type of plastic other than PET or PETE.

In various examples, the plastic product is a frame of eyewear.

In various aspects, a method for manufacturing a plastic product includes forming a mixture by mixing shredded plastic particles with an uncured matrix, the uncured matrix comprising an uncured resin, injecting or pouring the mixture into a mold, and curing the uncured matrix within the mixture at a temperature that is less than 110 degrees Celsius. Curing the uncured matrix within the mixture may form a cured matrix that comprises a cured resin.

In various examples, each of the shredded plastic particles defines a size of less than 0.5 mm.

In various examples, at least some of the shredded plastic particles defines a size of greater than 0.3 mm.

In various examples, a ratio between a volume of shredded plastic particles within the mixture and a volume of the uncured matrix within the mixture is at least 1:1.

In various examples, the shredded plastic particles comprise primarily of polyethylene terephthalate (PET or PETE), high-density polyethylene (HDPE), polyvinyl chloride (PVC), low-density polyethylene (LDPE), polypropylene (PP), polystyrene (PS), polycarbonate (PC), acrylic (PMMA), or a combination thereof.

In various examples, at least ten percent of the shredded plastic particles comprise primarily of PET or PETE and the other shredded plastic particles comprise primarily of a type of plastic other than PET or PETE.

In various examples, curing the uncured matrix within the mixture comprises curing the uncured matrix within the mixture while the mixture is positioned within the mold.

In various examples, the method comprises injecting the mixture into the mold.

In various examples, the cured matrix comprises the shredded plastic particles that are distinct from the cured resin.

In various examples, the method includes shredding a plurality of plastic objects to form the shredded plastic particles.

In various examples, at least some of the plurality of plastic objects are plastic consumer waste material that includes debris on a surface thereof, and wherein the debris is mixed with the uncured matrix.

In various examples, the method includes maintaining a temperature of the shredded plastic particles and the mixture at a temperature that is less than 110 degrees Celsius.

In various examples, the shredded plastic particles remain unmelted within the cured matrix.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms above, non-limiting and non-exhaustive embodiments of the subject disclosure are described with reference to the following figures, which are not necessarily drawn to scale and wherein like reference numerals refer to like parts throughout the various views unless otherwise specified. The components illustrated in the figures may or may not be present in certain embodiments described herein. Some embodiments may include fewer (or more) components than those shown in the figures.

FIG. 1 provides a perspective view of eyewear, in accordance with an example embodiment.

FIG. 2 provides a perspective view of eyewear, in accordance with an example embodiment.

FIG. 3 provides a flowchart of a method, in accordance with an example embodiment.

### DETAILED DESCRIPTION

One or more embodiments are now more fully described with reference to the accompanying drawings, wherein like reference numerals are used to refer to like elements throughout and in which some, but not all embodiments of the inventions are shown. In the following description, for purposes of explanation, numerous specific details are set forth in order to provide a thorough understanding of the various embodiments. It is evident, however, that the various embodiments can be practiced without these specific details. It should be understood that some, but not all embodiments are shown and described herein. Indeed, the embodiments may be embodied in many different forms, and accordingly this disclosure should not be construed as limited to the embodiments set forth herein. Rather, these embodiments are provided so that this disclosure will satisfy applicable legal requirements.

As used herein, the term “exemplary” means serving as an example, instance, or illustration. Any aspect or design described herein as “exemplary” is not necessarily to be construed as preferred or advantageous over other aspects or designs. Rather, use of the word exemplary is intended to present concepts in a concrete fashion. In addition, while a particular feature may be disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms “coupled,” “fixed,” “attached to,” and the like refer to both direct coupling, fixing, or attaching, as well as indirect coupling, fixing, or attaching through one or more intermediate components or features, unless otherwise specified herein.

As used herein, terms of approximation, such as “approximately,” “substantially,” or “about,” refer to being within manufacturing or engineering tolerances. For example, terms of approximation may refer to being within a five percent margin of error.

### Exemplary Plastic Product

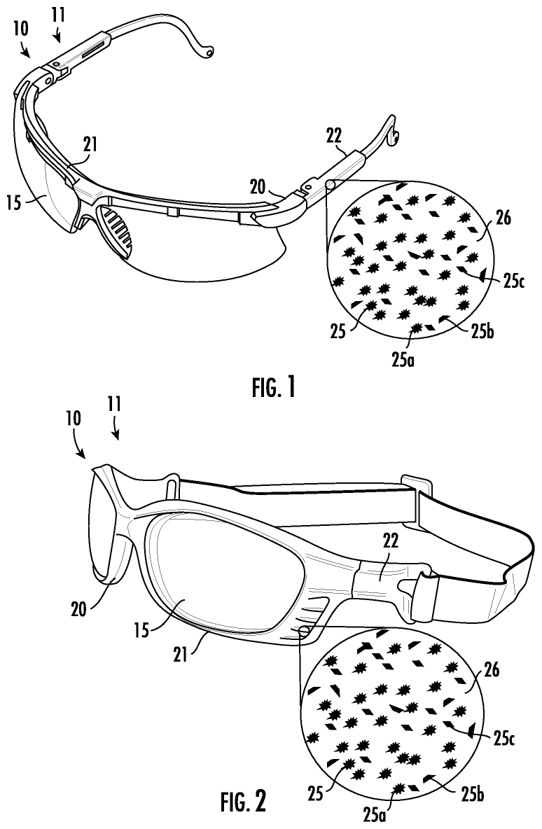

Referring now to FIG. 1 and FIG. 2, perspective views of plastic products 10 are provided, in accordance with various example embodiments. The plastic products 10 may be configured as eyewear 11. The eyewear 11 of the present disclosure can be of any type. For example, the eyewear 11 may be safety eyewear, fashion eyewear, reading eyewear, sunglasses, etc. In various examples, the eyewear 11 may be safety glasses, such as the safety glasses depicted in FIG. 1. In various examples, the eyewear 11 may be safety goggles, such as the safety goggles depicted in FIG. 2.

The eyewear 11 may include a frame 20. The frame 20 may be configured to be worn by a wearer. For example, the frame 20 may be configured to hold one or more transparent members 15, such as one or more lens, that is to be positioned in front of the eyes of the wearer. The frame 20 may include a rim 21 that is configured to hold the one or more transparent members 15. The rim 21 may be coupled to temples 22 of the frame 20.

Even though the plastic product 10 of the present disclosure is often referred to in the context of eyewear 11, it should be understood that other plastic products 10 are contemplated and can be manufactured using the methods discloses herein. For example, the plastic product 10 may be a consumer good or a component of a consumer good, such as plastic furniture, a plastic toy, a plastic storage container, a plastic home good, a plastic housing and plastic body for a device, such as an electrical device, etc.

Plastic products 10, such as the frame 20 of the eyewear 11 of FIG. 1 and FIG. 2, may include a plurality of shredded plastic particles 25 that are disposed within a cured matrix 26. The cured matrix 26 may include a cured resin, a plasticizer, or a combination thereof. The shredded plastic particles 25 may be distinct from the cured matrix 26. For example, the shredded plastic particles 25 may be distinguishable from the cured matrix 26 when the frame 20 is viewed under magnification, such as viewed at 50× magnification. The shredded plastic particles 25 can be dispersed within the cured matrix 26, such that the cured matrix 26 forms a continuous matrix phase surrounding a dispersed phase of the shredded plastic particles 25.

The shredded plastic particles 25 may contain polyethylene terephthalate (PET or PETE), high-density polyethylene (HDPE), polyvinyl chloride (PVC), low-density polyethylene (LDPE), polypropylene (PP), polystyrene (PS), polycarbonate (PC), acrylic (PMMA), or a combination thereof. In various examples, some of the shredded plastic particles 25 are of a different type of plastic than other shredded plastic particles 25. For example, some of the shredded plastic particles 25 (e.g., at least ten percent, such as at least thirty percent, such as at least seventy percent of the total quantity or total volume of shredded plastic particles 25) may contain PET or PETE and the remaining shredded plastic particles 25 may contain something other than PET or PETE (e.g., HDPE, PVC, LDPE, PP, PS, PC, PMMA, or a combination thereof). Each shredded plastic particle 25 can substantially consist of a certain type of plastic and not any other type of plastic. For example, a shredded plastic particle 25 may include PET or PETE but may not include something other than PET or PETE (e.g., HDPE, PVC, LDPE, PP, PS, PC, PMMA, or a combination thereof).

In various examples, the shredded plastic particles 25 collectively contain at least two different types of plastic, such as at least three different types of plastic, such as at least four different types of plastic, such as at least five different types of plastic, the different types of plastic being PET or PETE, HDPE, PVC, LDPE, PP, PS, PC, and PMMA. For example, a first plurality of shredded plastic particles 25a may be of a first type of plastic (e.g., consist of only a first type of plastic) and a second plurality of shredded plastic particles 25b may be of a second type of plastic (e.g., consist of only a second type of plastic). A third plurality of shredded plastic particles 25c may be of a third type of plastic (e.g., consist of only a third type of plastic), and so forth. In various examples, at least ten percent, such as at least thirty percent, such as at least seventy percent of the plurality of shredded plastic particles 25 are the first plurality of shredded plastic particles 25a and at least ten percent, such as at least thirty percent of the plurality of shredded plastic particles 25 are the second plurality of shredded plastic particles 25b. At least ten percent, such as at least thirty percent of the plurality of shredded plastic particles 25 may be the third plurality of shredded plastic particles 25c.

Each of the shredded plastic particles 25 may define a size of less than 0.5 millimeter (mm). For example, each of the shredded plastic particles 25 may define a size of at least 0.1 mm and up to 0.5 mm. In various examples, at least some of the shredded plastic particles 25 (e.g., at least twenty percent, such as at least fifty percent of the total quantity or total volume of the shredded plastic particles 25 within the frame 20) define a size that is greater than 0.2 mm and up to 0.5 mm, such as at least 0.3 mm and up to 0.5 mm.

In various examples, a ratio (VP:VM) between a volume of shredded plastic particles 25 within the plastic product 10 (VP) and a volume of the cured matrix 26 within the plastic product 10 (VM) is at least 1:1, such as at least 2:1, such as at least 3:1. Stated differently, the volume of the shredded plastic particles 25 within the plastic product 10 (VP) may be greater than the volume of the cured matrix 26 within the plastic product 10 (VM).

### Exemplary Methods for Manufacturing Plastic Products 10

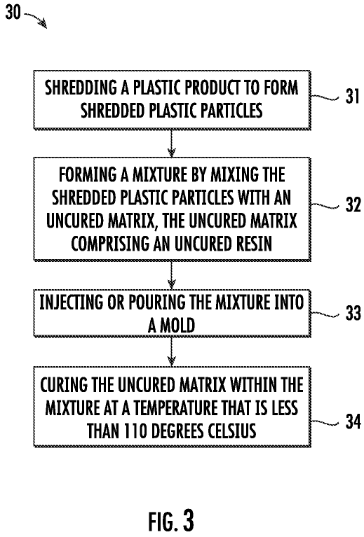

Referring now to FIG. 3, a flowchart of a method 30 of manufacturing a plastic product 10 is provided, in accordance with an example embodiment. The method 30 may be used to manufacture a plastic frame 20 for eyewear 11, such as the frames of FIG. 1 and FIG. 2. In various examples, other plastic products 10 may be manufactured using the method 30, such as plastic furniture, plastic toys, plastic storage containers, plastic home goods, plastic housings and plastic bodies for devices, such as electrical devices, etc.

The method 30 may include a step 31 of shredding a plurality of plastic objects to form a plurality of shredded plastic particles 25. Each plastic object may comprise primarily of PET or PETE, HDPE, PVC, LDPE, PP, PS, PC, or PMMA. Each plastic object may consist only one of PET or PETE, HDPE, PVC, LDPE, PP, PS, PC, or PMMA. As used herein, the term “comprise primarily of” refers to comprising the substance in a concentration of at least ninety percent, such as at least ninety-five percent, such as at least ninety-nine percent.

At least some of the plastic objects may be plastic consumer waste materials (e.g., post-consumer plastic). For example, an owner or user of some of the plastic objects may have disposed of the plastic object with the intent that the plastic object be reused or recycled.

In various examples, at least some of the plastic objects are consumer goods, such as food, drink, and/or toiletry plastic containers manufactured from PET or PETE, such as soft drink bottles, juice bottles, water bottles, shampoo/conditioner bottles, liquid hand soap bottles, etc. In various examples, at least some of the plastic objects are manufactured from HDPE, such as toys, food storage containers, reusable water bottles, waste receptacles, etc. In various examples, at least some of the plastic objects are manufactured from PVC, such as rigid pipes, flooring, etc. In various examples, at least some of the plastic objects are manufactured from PP, such as plastic containers, reusable water bottles, outdoor furniture, toys, etc. In various examples, at least some of the plastic objects are manufactured from PS, such as the plastic portions of household appliances.

In various examples, each of the plurality of plastic objects may be cleaned (i.e., washed or sanitized) prior to the step 31 of shredding the plurality of plastic objects. However, cleaning the plurality of plastic objects may not be necessary and may not be performed. As such, any debris that may be on a surface of the plastic objects may also be shredded along with the plastic. The debris may include substances that are often used by consumers and purchased in plastic containers, such as food, beverages, soaps, cleaning products, etc.

In various examples, the plastic objects are of at least two different types of plastic, such as at least three different types of plastic, such as at least four different types of plastic, such as at least five different types of plastic, the different types of plastic being PET or PETE, HDPE, PVC, LDPE, PP, PS, PC, and PMMA. For example, a first plurality of plastic objects may be of a first type of plastic and a second plurality of plastic objects may be of a second type of plastic. A third plurality of plastic objects may be of a third type of plastic, and so forth. In various examples, at least ten percent, such as at least thirty percent, such as at least seventy percent of a total volume of the plastic objects are the first plurality of plastic objects and at least ten percent, such as at least thirty percent of the total volume of the plastic objects are the second plurality of plastic objects. At least ten percent, such as at least thirty percent the total volume of the plastic objects are the third plurality of plastic objects.

Each of the plurality of plastic objects may have a melting point that is greater than 110 degrees Celsius. For example, each of the first plurality of plastic objects and the second plurality of plastic objects may comprise primarily of a plastic that has a melting point that is greater than 110 degrees Celsius.

Because the plastic objects may be of at least two different types of plastic, the shredded plastic particles 25 that are manufactured from shredding the plastic objects may contain at least two different types of plastic, such as at least three different types of plastic, such as at least four different types of plastic, such as at least five different types of plastic, the different types of plastic being PET or PETE, HDPE, PVC, LDPE, PP, PS, PC, and PMMA. For example, a first plurality of shredded plastic particles 25a may be of a first type of plastic and a second plurality of shredded plastic particles 25b may be of a second type of plastic. A third plurality of shredded plastic particles 25c may be of a third type of plastic, and so forth. In various examples, at least ten percent, such as at least thirty percent, such as at least seventy percent of the plurality of shredded plastic particles 25 are the first plurality of shredded plastic particles 25a and at least ten percent, such as at least thirty percent of the plurality of shredded plastic particles 25 are the second plurality of shredded plastic particles 25b. At least ten percent, such as at least thirty percent of the plurality of shredded plastic particles 25 may be the third plurality of shredded plastic particles 25c. Also, each of the plurality of shredded plastic particles 25 may have a melting point that is greater than 110 degrees Celsius. For example, each of the first plurality of shredded plastic particles 25 and the second plurality of shredded plastic particles 25 may comprise primarily of a plastic that has a melting point that is greater than 110 degrees Celsius.

The step 31 of shredding the plurality of plastic objects may include shredding each plastic object such that each of the shredded plastic particles 25 may define a size of less than 0.5 mm. For example, the plastic objects may be shredded into plastic particles that define a size of at least 0.1 mm and up to 0.5 mm. In various examples, the plastic objects may be shredded such that at least some of the resulting shredded plastic particles 25 (e.g., at least twenty percent, such as at least fifty percent of the total quantity of shredded plastic particles 25) define a size that is greater than 0.2 mm and up to 0.5 mm, such as at least 0.3 mm and up to 0.5 mm.

The method 30 may include a step 32 of forming a mixture by mixing the shredded plastic particles 25 with an uncured matrix. The uncured matrix may include an uncured resin, such as an uncured epoxy resin. The uncured matrix may include other substances, such as plasticizers, resin catalysts, and/or hardeners. The uncured matrix may be heated to melt the uncured matrix. For example, the uncured matrix may be heated up to a temperature that is less than 110 degrees Celsius to melt the uncured matrix so that the uncured matrix becomes a fluid, such as a liquid.

In various examples, forming the mixture includes mixing a volume of the shredded plastic particles 25 (VP) with a volume of the uncured matrix (VM) such that a ratio (VP:VM) between the volume of shredded plastic particles 25 within the mixture (VP) and the volume of the cured matrix 26 within the mixture (VM) is at least 1:1, such as at least 2:1, such as at least 3:1. Stated differently, the volume of the shredded plastic particles 25 within the mixture (VP) may be greater than the volume of the cured matrix 26 within the mixture (VM).

As mentioned, the plastic objects may not be cleaned prior to shredding. As such, debris that may have been on the plastic object may be included within the volume of the shredded plastic particles 25. Therefore, the step 32 of forming the mixture may include also mixing the debris with the uncured matrix.

The method 30 may include a step 33 of injecting or pouring the mixture into a mold. For example, a mold may be provided that corresponds to at least a portion of the shape of the plastic product 10 to be manufactured. In various examples, the shape of the mold corresponds to a shape of a rim 21 or a temple 22 of a frame 20 for eyewear 11, such as the eyewear 11 of FIG. 1 or FIG. 2.

The method 30 may include a step 34 of curing the uncured matrix within the mixture at a temperature that is less than 110 degrees Celsius. Curing the uncured matrix within the mixture may form a cured matrix 26 that comprises a cured resin. Curing the uncured matrix may include curing the uncured matrix while the mixture is positioned within the mold.

The method 30 may include maintaining a temperature of the plastic particles and/or the mixture at a temperature that is less than 110 degrees Celsius and/or preventing and/or not allowing a temperature of the shredded plastic particles 25 to exceed 110 degrees Celsius. Stated differently, the method 30 does not include melting the plastic particles. For example, the shredded plastic particles 25 are not melted prior to being mixed with the uncured matrix or after the shredded plastic particles 25 are mixed with the uncured matrix. Further, the shredded plastic particles 25 are not melted while the uncured matrix is cured.

When each of the plurality of shredded plastic particles 25 comprise primarily of a plastic that has a melting point that is greater than 110 degrees Celsius, not allowing the shredded plastic particles 25 to exceed a temperature of 110 degrees Celsius maintains the solid state of the shredded plastic particles 25. As such, the final plastic product 10 includes a plurality of shredded plastic particles 25 that are distinct from the cured matrix 26.

A plastic product 10 that includes a plurality of shredded plastic particles 25 that are distinct from the cured matrix 26 has various benefits. For example, the plurality of shredded plastic particles 25 may increase the strength of the plastic product 10. In various examples, the shredded plastic particles 25 can be dispersed within the cured matrix 26, such that the cured matrix 26 forms a continuous matrix phase surrounding a dispersed phase of the shredded plastic particles 25, which may increase the strength of the plastic product 10.

Also, including a plurality of shredded plastic particles 25 that are distinct from the cured matrix 26 may simplify the manufacturing process to manufacture the plastic product 10. For example, as mentioned, it may be unnecessary to clean the plastic objects prior to shredding. Also, because it is preferred that the shredded plastic particles 25 remain solid, it is unnecessary to use temperatures above 110 degrees in the manufacturing process, which may decrease energy costs associated with manufacturing the plastic product 10.

Additionally, because plastic objects that include various different types of plastics may be used to manufacture the shredded plastic particles 25, it is unnecessary to sort the plurality of plastic objects by plastic type prior to shredding the plastic objects. Not needing to sort the plurality of plastic objects simplifies the manufacturing process of the plastic product 10 and may reduce the amount of time or costs associated with manufacturing the plastic product 10.

Lastly, because previously used plastic objects are used the manufacture the plastic product 10, the plastic product 10 contains at least some recycled material. As such, manufacturing the plastic product 10 may have less of a negative environmental impact than manufacturing the plastic product 10 with, for example, all new materials.

### CONCLUSION

The above descriptions of various embodiments of the subject disclosure and corresponding figures and what is described in the Abstract, are described herein for illustrative purposes, and are not intended to be exhaustive or to limit the disclosed embodiments to the precise forms disclosed. It is to be understood that one of ordinary skill in the art may recognize that other embodiments having modifications, permutations, combinations, and additions can be implemented for performing the same, similar, alternative, or substitute functions of the disclosed subject matter, and are therefore considered within the scope of this disclosure. Therefore, the disclosed subject matter should not be limited to any single embodiment described herein, but rather should be construed in breadth and scope in accordance with the appended claims below. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A plastic product comprising:
shredded plastic particles disposed within a cured matrix, the cured matrix comprising a cured resin,
wherein the shredded plastic particles are distinct from the cured matrix.

2. The plastic product of claim 1, wherein each of the shredded plastic particles defines a size of less than 0.5 mm.

3. The plastic product of claim 2, wherein at least some of the shredded plastic particles defines a size of greater than 0.3 mm.

4. The plastic product of claim 1, wherein a ratio between a volume of shredded plastic particles within the plastic product and a volume of the cured matrix within the plastic product is at least 1:1.

5. The plastic product of claim 1, wherein the shredded plastic particles comprise primarily of polyethylene terephthalate (PET or PETE), high-density polyethylene (HDPE), polyvinyl chloride (PVC), low-density polyethylene (LDPE), polypropylene (PP), polystyrene (PS), polycarbonate (PC), acrylic (PMMA), or a combination thereof.

6. The plastic product of claim 5, wherein at least ten percent of the shredded plastic particles comprise primarily of PET or PETE and the other shredded plastic particles comprise primarily of a type of plastic other than PET or PETE.

7. The plastic product of claim 1, wherein the plastic product is a frame of eyewear.

8. A method for manufacturing a plastic product, the method comprising:
forming a mixture by mixing shredded plastic particles with an uncured matrix, the uncured matrix comprising an uncured resin;
injecting or pouring the mixture into a mold; and
curing the uncured matrix within the mixture at a temperature that is less than 110 degrees Celsius,
wherein curing the uncured matrix within the mixture forms a cured matrix that comprises a cured resin.

9. The method of claim 8, wherein each of the shredded plastic particles defines a size of less than 0.5 mm.

10. The method of claim 8, wherein at least some of the shredded plastic particles defines a size of greater than 0.3 mm.

11. The method of claim 8, wherein a ratio between a volume of shredded plastic particles within the mixture and a volume of the uncured matrix within the mixture is at least 1:1.

12. The method of claim 8, wherein the shredded plastic particles comprise primarily of polyethylene terephthalate (PET or PETE), high-density polyethylene (HDPE), polyvinyl chloride (PVC), low-density polyethylene (LDPE), polypropylene (PP), polystyrene (PS), polycarbonate (PC), acrylic (PMMA), or a combination thereof.

13. The method of claim 12, wherein at least ten percent of the shredded plastic particles comprise primarily of PET or PETE and the other shredded plastic particles comprise primarily of a type of plastic other than PET or PETE.

14. The method of claim 8, wherein curing the uncured matrix within the mixture comprises curing the uncured matrix within the mixture while the mixture is positioned within the mold.

15. The method of claim 8, wherein the method comprises injecting the mixture into the mold.

16. The method of claim 8, wherein the cured matrix comprises the shredded plastic particles that are distinct from the cured resin.

17. The method of claim 8, further comprising shredding a plurality of plastic objects to form the shredded plastic particles.

18. The method of claim 17, wherein at least some of the plurality of plastic objects are plastic consumer waste material that includes debris on a surface thereof, and wherein the debris is mixed with the uncured matrix.

19. The method of claim 8, further comprising maintaining a temperature of the shredded plastic particles and the mixture at a temperature that is less than 110 degrees Celsius.

20. The method of claim 8, wherein the shredded plastic particles remain unmelted within the cured matrix.
